(19) United States
(12) Patent Application Publication
(10) Pub. No.: US 2025/0385399 A1
(43) Pub. Date: Dec. 18, 2025

(54) BATTERY CELL WITH DOWEL FOR WELDING ELECTRODE TABS

(71) Applicant: GM GLOBAL TECHNOLOGY OPERATIONS LLC, Detroit, MI (US)

(72) Inventors: Matthew A. Celentano, Berkley, MI (US); Seung-Woo Chu, Sterling Heights, MI (US)

(73) Assignee: GM GLOBAL TECHNOLOGY OPERATIONS LLC, Detroit, MI (US)

(21) Appl. No.: 18/743,901

(22) Filed: Jun. 14, 2024

(51) Int. Cl. H01M 50/536; H01M 50/169; H01M 50/533; H01M 50/55

(52) U.S. Cl. CPC H01M 50/536; H01M 50/169; H01M 50/533; H01M 50/55; H01M 2220/20

(57) ABSTRACT

A secondary battery cell includes a battery cell receptacle and an electrode assembly having multiple electrodes with each of the electrodes including a cathode tab and an anode tab. The electrode assembly is at least partially enclosed within the battery cell receptacle. The secondary battery cell includes a dowel extending through a tab dowel opening in at least one of the cathode tab or the anode tab on each of electrodes and a cap assembly having a cathode portion connecting the cathode tab on each of the electrodes to a negative terminal, an anode portion connecting the anode tab on each of the electrodes to a positive terminal, and a cap at least partially forming a battery enclosure for the electrode assembly with the battery cell receptacle. The dowel also forms a portion of a connection in one of the cathode portion or the anode portion.

### BACKGROUND

The present disclosure related to a structure and method of manufacturing a secondary battery cell.

Lithium-ion batteries are desirable candidates for powering electronic devices in the consumer, automotive, naval, marine, and aerospace industries due to their relatively high energy density, high power density, lack of memory effect, and long cycle life, as compared to other rechargeable battery technologies, including lead-acid batteries, nickel-cadmium and nickel-metal-hydride batteries. The widespread commercialization of lithium batteries, however, is dependent upon their ensured performance under normal operating conditions, in the event of manufacturing defects, upon aging, as well as under a variety of abuse conditions, including exposure to high temperatures, overcharge, over-discharge, and exposure to external forces that physically damage one or more internal components thereof. Conditions that affect the thermal, chemical, electrical, and/or physical stability of lithium batteries may increase the internal temperature of such batteries, which may, in turn, set-off additional undesirable events and/or chemical reactions within the batteries that may lead to additional heat generation.

Battery cells are produced in different configurations. Pouch battery cells may be flat, thin battery cells encased in a flexible laminated aluminum pouch and may be useful to stack a plurality of the pouch battery cells in a relatively small package space. Metal can battery cells may be encased in a rigid, protective case. Examples of metal can battery cells may include examples of prismatic battery cells, which may include a rectangular outer case.

### SUMMARY

Disclosed herein is a secondary battery cell. The secondary battery cell includes a battery cell receptacle and an electrode assembly having multiple electrodes with each of the electrodes including a cathode tab and an anode tab. The electrode assembly is at least partially enclosed within the battery cell receptacle. The secondary battery cell includes a dowel extending through a tab dowel opening in at least one of the cathode tab or the anode tab on each of electrodes and a cap assembly having a cathode portion connecting the cathode tab on each of the electrodes to a negative terminal, an anode portion connecting the anode tab on each of the electrodes to a positive terminal, and a cap at least partially forming a battery enclosure for the electrode assembly with the battery cell receptacle. The dowel also forms a portion of a connection in one of the cathode portion or the anode portion.

In one aspect of the disclosure a distal end of the dowel extends transversely to a portion of the dowel extending through the tab dowel opening on each of the electrodes.

In one aspect of the disclosure the tab dowel opening includes a perimeter having a rectangular shape.

In one aspect of the disclosure a tab portion of the dowel extending through the tab dowel opening on each of the electrodes is parallel to a cap portion of the dowel attached to the cap assembly.

In one aspect of the disclosure a mid-portion of the dowel located between the tab portion and the cap portion extends transversely to the tab portion and the cap portion.

In one aspect of the disclosure the battery cell receptacle includes one of a pouch or a can.

In one aspect of the disclosure the dowel is glued to a corresponding one of the cathode tab or the anode tab on each of the electrodes.

In one aspect of the disclosure the dowel includes a cathode dowel and the tab dowel opening includes a cathode tab dowel opening in the cathode tab on each of the electrodes with the cathode dowel extending through the cathode dowel opening on each of the electrodes.

In one aspect of the disclosure the dowel includes an anode dowel and the tab dowel opening includes an anode tab dowel opening in the anode tab on each of the electrodes with the anode dowel extending through the anode dowel opening on each of the electrodes.

In one aspect of the disclosure the dowel includes a cathode dowel and an anode dowel, the tab dowel opening includes a cathode tab dowel opening in the cathode tab of each of the electrodes with the cathode dowel extending through the cathode dowel opening on each of the f electrodes and an anode dowel opening in the anode tab on each of the electrodes with the anode dowel extending through the anode dowel opening on each of the electrodes.

Disclosed herein is a method of manufacturing a secondary battery cell. The method includes stacking electrodes onto a cathode dowel and onto an anode dowel to form an electrode assembly. The cathode dowel extends through a cathode tab dowel opening in a cathode tab on each of the electrodes and the anode dowel extends through an anode tab dowel opening in an anode tab in each of the electrodes. The method also includes folding a portion of the cathode tab on each of the electrodes distal of the cathode tab dowel opening onto the cathode dowel and folding a portion of the anode tab on each of the electrodes distal of the anode tab dowel opening onto the anode dowel. The method also includes welding the portion of the cathode tab distal of the cathode tab dowel opening on each of the electrodes onto the cathode dowel and welding the portion of the anode tabs distal of the anode tab dowel opening on each of the electrodes onto the anode dowel. The method further includes enclosing the electrode assembly at least partially within a battery cell receptacle with a cap assembly. The cap assembly includes a negative terminal in electrical communication with cathode tab on each of the electrodes and a positive terminal in electrical communication the anode tabs on each of the electrodes.

In one aspect of the disclosure the method includes bending a distal end of the cathode dowel to be transverse to a tab portion of the cathode dowel extending through the cathode tab dowel opening on each of the electrodes after stacking the electrodes.

In one aspect of the disclosure the method includes gluing the cathode tab on each of the electrodes to the cathode dowel and glueing the anode tab on each of the electrodes to the anode dowel.

In one aspect of the disclosure the method includes bending a distal end of the anode dowel to be transverse to a tab portion of the anode dowel extending through the anode tab dowel opening on each of the electrodes after stacking the electrodes.

In one aspect of the disclosure the method includes bending a mid-portion of the cathode dowel such that the tab portion of the cathode dowel is parallel to a cap portion of the cathode dowel attached to the cap assembly, wherein the mid-portion of the cathode dowel extends transversely to the tab portion of the cathode dowel.

In one aspect of the disclosure the method includes bending a mid-portion of the anode dowel such that a tab portion of the anode dowel is parallel to a cap portion of the anode dowel attached to the cap assembly, wherein the mid-portion of the anode dowel extends transversely to the tab portion of the anode dowel.

In one aspect of the disclosure folding the portion of the cathode tab on each of the electrodes includes folding a first portion of the cathode tab distal of the cathode tab dowel opening on each of the electrodes in a first direction and folding a second portion of the cathode tab distal of the cathode tab dowel opening on each of the electrodes in a second direction opposite the first direction.

In one aspect of the disclosure the method includes welding a cap plate of the cap assembly to the battery cell receptacle.

In one aspect of the disclosure the cap assembly at least partially encloses the electrode assembly within the battery cell receptacle.

Disclosed herein is a vehicle. The vehicle includes a battery pack having secondary battery cells. At least one of the secondary battery cells includes a battery cell receptacle and an electrode assembly having multiple electrodes with each of the electrodes including a cathode tab and an anode tab. The electrode assembly is at least partially enclosed within the battery cell receptacle. The secondary battery cell includes a dowel extending through a tab dowel opening in at least one of the cathode tab or the anode tab on each of electrodes and a cap assembly having a cathode portion connecting the cathode tab on each of the electrodes to a negative terminal, an anode portion connecting the anode tab on each of the electrodes to a positive terminal, and a cap at least partially forming a battery enclosure for the electrode assembly with the battery cell receptacle. The dowel also forms a portion of a connection in one of the cathode portion or the anode portion.

### BRIEF DESCRIPTION OF DRAWINGS

FIG. 1 is a schematic illustration of a battery pack according to one example embodiment of this disclosure incorporated into a vehicle.

FIG. 2 is a schematic illustration of an electrode assembly with a cathode dowel and an anode dowel.

FIG. 3A is a schematic illustration of an example electrode tab.

FIG. 3B is a schematic illustration of another example electrode tab.

FIG. 3C is a schematic illustration of yet another example electrode tab.

FIG. 4 is a schematic illustration of assembling the electrode assembly of FIG. 2.

FIG. 5 is a schematic illustration of assembling the cathode dowel relative to the cathode tabs on the electrode assembly.

FIG. 6 is a schematic illustration of a cap assembly attached to the cathode dowel.

FIG. 7 is a cross-sectional view taken along line 7-7 of FIG. 6.

FIG. 8 is a schematic illustration of the cap assembly of FIG. 6 positioned relative to the electrode assembly for installation into a battery cell receptacle.

FIG. 9 is a schematic illustration of an example secondary battery cell with internal components illustrated within the battery cell receptacle.

FIG. 10 is a flow diagram of an example method for manufacturing the example secondary battery cell of FIG. 9 in accordance with one or more exemplary embodiments.

Some embodiments of the present disclosure are now described, by way of example only, and with reference to the accompanying drawings. The same reference number represents the same element or the same type of element on all drawings.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

Embodiments disclosed herein generally provide a secondary battery cell with improved connections to cathode and anode tabs on the electrodes. Due to the thickness of the material of the cathode and anode tabs, preventing damage or tears to them can improve battery longevity and performance. The improved connection can be accomplished through the use of cathode and anode dowels that engage respective the cathode and anode tabs in parallel within an enclosure for the secondary battery cell. The cathode and anode dowels then form a portion of the connection to output terminals for the secondary battery cell that can be linked together to form a battery pack.

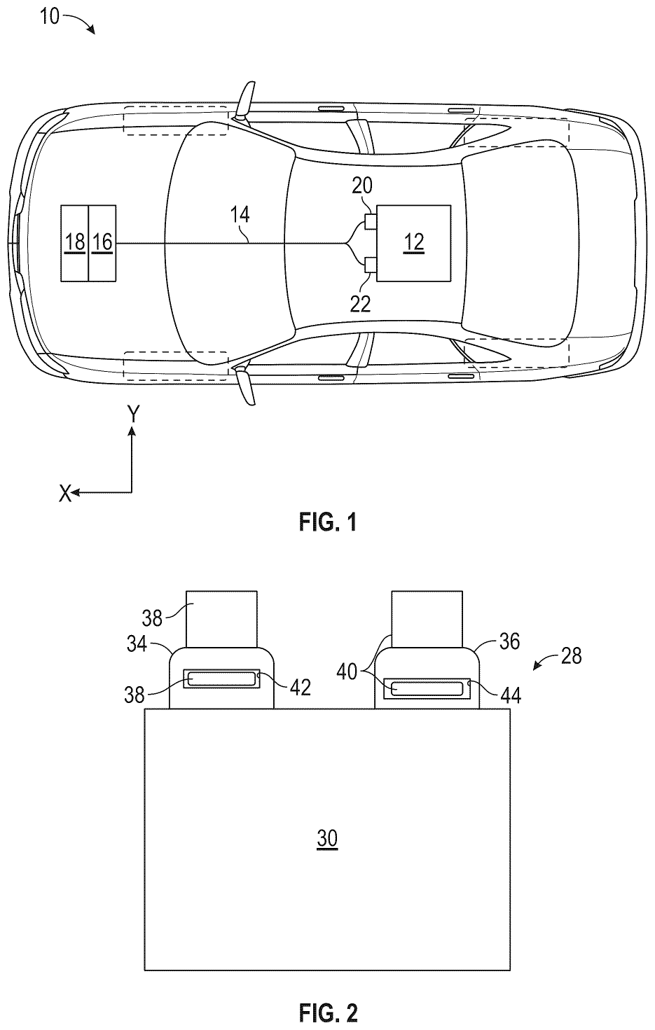

Referring to the FIGS., wherein like numerals indicate like parts referring to the drawings, wherein like reference numbers refer to like components, FIG. 1 is a schematic plan diagram illustrating a context of a system is shown. The system may implement a vehicle 10. The vehicle 10 generally comprises a battery pack 12, a harness 14, a controller 16, and a motor 18. The battery pack 12 may include a positive battery pack terminal 20 and a negative battery pack terminal 22. For the purposes of explanation, a front of the vehicle 10 may be aligned in a positive X direction. A right side of the vehicle 10 (as seen looking down at a top of the vehicle 10) may be aligned in a positive Y direction. The positive Y direction may be perpendicular to the positive X direction.

The vehicle 10 may include, but is not limited to, mobile objects such as a passenger vehicle, a truck, an autonomous vehicle, a gas-powered vehicle, an electric-powered vehicle, a hybrid vehicle, a motorcycle, a boat, a farm vehicle, a train and/or an aircraft. In some embodiments, the vehicle 10 may include stationary objects such as billboards, kiosks and/or marquees. Other types of vehicles 10 may be implemented to meet the design criteria of a particular application.

The battery pack 12 may implement a high-voltage battery pack configured to store electrical energy. The battery pack 12 is generally operational to receive electrical power from the controller 16 and provide electrical power to the controller 16. The battery pack 12 may include multiple battery modules electrically connected in series and/or in parallel between the positive battery pack terminal 20 and the negative battery pack terminal 22. In various embodiments, the battery pack 12 may provide approximately 400 to 800 volts DC (direct current) electrical potential between the positive battery pack terminal 20 and the negative battery pack terminal 22. Other battery voltages may be implemented to meet the design criteria of a particular application. The positive battery pack terminal 20 and the negative battery pack terminal 22 may be physically and electrically connected to the harness 14.

The harness 14 may implement an electrical harness. The harness 14 is generally operational to carry electrical power between the controller 16 and the battery pack 12. In a charging mode, the harness 14 may transfer the electrical power from the controller 16 to the battery pack 12. In a discharging mode, the electrical power may flow along the harness 14 from the battery pack 12 to the controller 16.

The controller 16 may implement a battery controller. The controller 16 is generally operational to transfer electrical power to the battery pack 12 in the charging mode to charge the battery pack 12. The controller 16 may draw electrical power from the battery pack 12 in the discharge mode. The electrical power received from the battery pack 12 may be used to power the motor 18 and/or other loads within the vehicle 10.

The motor 18 may implement an electric motor. The motor 18, such as a traction motor, is generally operational to provide rotation and torque to drive wheels of the vehicle 10. The electrical power consumed by the motor 18 may be provided by the battery pack 12 and/or an alternator of the vehicle 10 under the control of the controller 16.

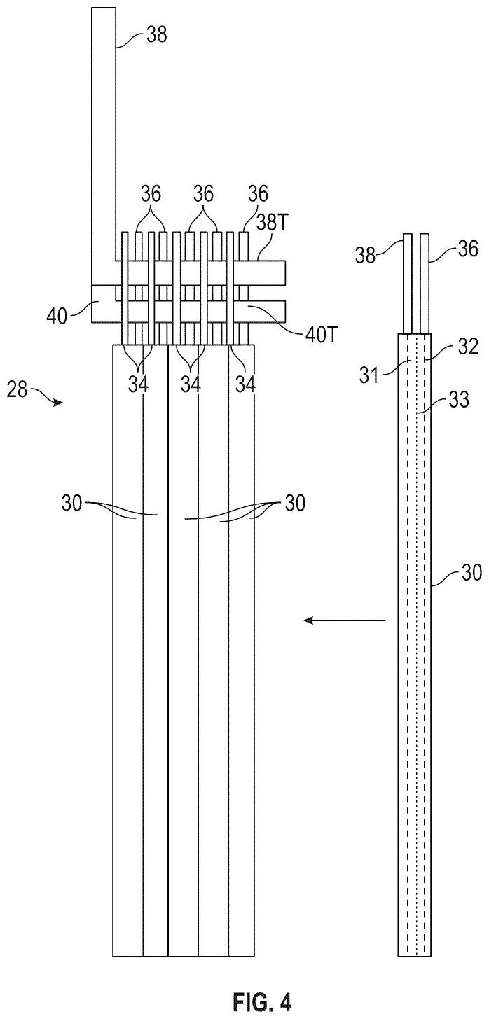

FIG. 2 illustrates an electrode assembly 28 formed by stacking individual electrodes 30 having a body portion enclosing a cathode 31 separated from an anode 32 by a separator plate 33 (FIG. 4). A cathode tab 34 is in electrical communication with the cathode 31 and an anode tab 36 is in electrical communication with the anode 32 on each of the electrodes 30. The cathode tab 34 and the anode tab 36 on each of the electrodes 30 are in electrical communication with a cathode dowel 38 and an anode dowel 40, respectively, as will be discussed in greater detail below. The cathode tab 34 and the cathode dowel 38 can be comprised of a similar material to the cathode 31, such as aluminum, and the anode tab 36 and the anode dowel 40 can be comprised of a similar material to the anode 32, such as copper.

In the illustrated example, a cathode tab dowel opening 42 is located in a central portion of and is defined along its perimeter by the cathode tab 34. Similarly, an anode tab dowel opening 44 is located in a central portion of and is defined along its perimeter by the anode tab 36. While the cathode and anode tab dowel openings 42 and 44 illustrated have a rectangular cross section, dowel openings of other shapes are applicable to this disclosure.

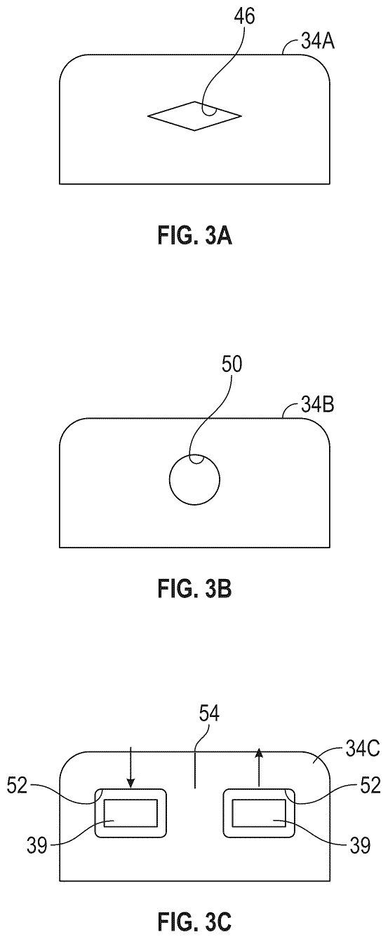

FIG. 3A illustrates another example cathode tab 34A having a cathode tab dowel opening 46 with a diamond shape defined along its perimeter and FIG. 3B illustrates yet another example cathode tab 34B having a cathode tab dowel opening 50 with a circular shape defined along its perimeter. FIG. 3C illustrates a further example cathode tab 34C having a pair of cathode tab dowel openings 52 that allow for a cathode dowel 39 having a pair of legs to extend through corresponding ones of the pair of cathode tab dowel openings 52. Also, the cathode tab 34C include a slit 54 in the cathode tab 34C that allows for a first portion of the cathode tab 34C outward from one of the cathode tab dowel openings 52 to move independently of a second portion of the cathode tab 34C outward of another one of the cathode tab dowel openings 52. In particular, the first and second portions of the cathode tab 34C can be folded over onto the cathode dowel 39 in opposite directions as will be discussed in greater detail below. While FIGS. 3A-3C illustrate cathode tabs 34A, 34B, and 34C, the cathode tab dowel openings 46, 50, and 52 are applicable to anode tabs. Also, the cathode and anode tabs 34 and 36 on a single electrode 30 can have cathode and anode tab openings 42 and 44, respectively, of different shapes.

FIG. 4 illustrates the electrodes 30 being stacked together on the cathode dowel 38 and the anode dowel 40 to form the electrode assembly 28. As the electrodes 30 are stacked onto each other, the cathode tab dowel openings 42 and the anode tab dowel openings 44 are aligned with the cathode dowel 38 and the anode dowel 40, respectively. In one example, glue may be used to secure the cathode tab 34 and the anode tab 36 to the cathode dowel 38 and anode dowel 40, respectively.

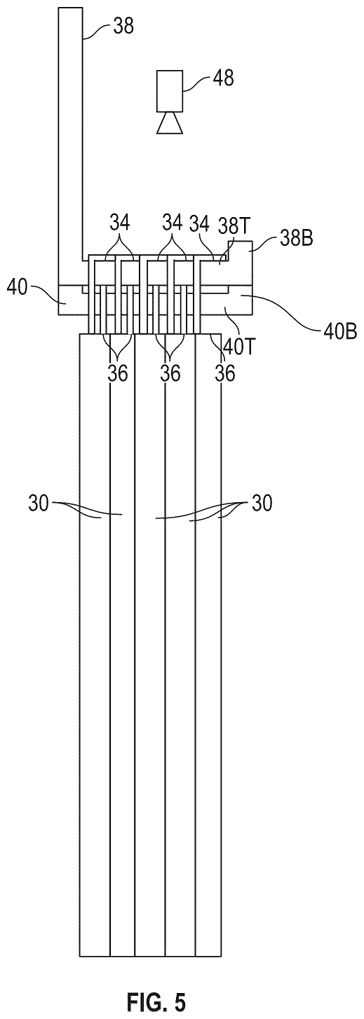

As shown in FIG. 5, the cathode dowel 38 includes a tab portion 38T extending through the cathode dowel tab openings 42 and the anode dowel 40 includes a tab portion 40T extending through the anode dowel tab openings 44. A distal end of the cathode dowel 38 is bent to include a cathode dowel distal bend 38B that extends perpendicular to or transverse to the tab portion 38T. Similarly, a distal end of the anode dowel 40 is bent to include an anode dowel distal bend 40B that extends perpendicular to or transverse to the tab portion 40T.

One feature of bending the distal end of the cathode and anode dowels 38 and 40 is a reduction in force on the cathode and anode tabs 34 and 36 along ends of the electrode assembly 28. This can prevent damage to the cathode and anode tabs 34 and 36 which could reduce secondary battery cell life or performance.

Also, a portion of the cathode tab 34 distal of the cathode tab dowel opening 42 on each of the electrodes 30 is folded and welded onto the cathode dowel 38. Similarly, a portion of the anode tab 36 distal of the anode tab dowel opening 44 on each of the electrodes 30 is folded and welded onto the anode dowel 40. In the illustrated example, the welding occurs with the welder 48, such as a laser welder.

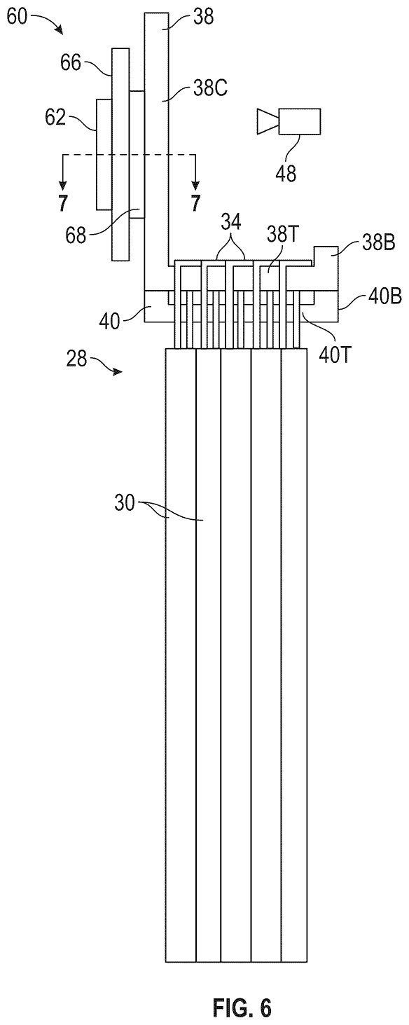

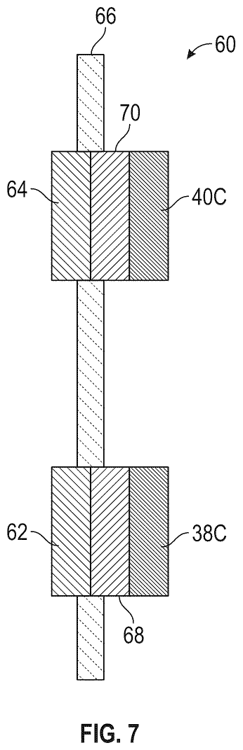

As shown in FIGS. 6-7, a cap assembly 60 is attached a cap portion 38C on the cathode dowel 38 and a cap portion 40C on the anode dowel 40. In the illustrated example, the cap assembly 60 includes a negative terminal 62, a positive terminal 64, a cap plate 66, a negative terminal weld plate 68, and a positive terminal weld plate 70. A cathode portion of the cap assembly 60 includes the negative terminal weld plate 68 welded directly to the cathode dowel 38 with the welder 48 and the negative terminal weld plate 68 is in electrical communication with the negative terminal 62. Similarly, an anode portion of the cap assembly 60 includes the positive terminal weld plate 70 welded directly to the anode dowel 40 with the welder 48 and the positive terminal weld plate 70 is in electrical communication with the positive terminal 64. The cap plate 66 maintains the positive and negative terminals 62 and 64 in electrical isolation and forms a portion of a battery cell enclosure 78 as discussed in greater detail below. The cap plate 66 may be a single piece or material or multiple pieces of material.

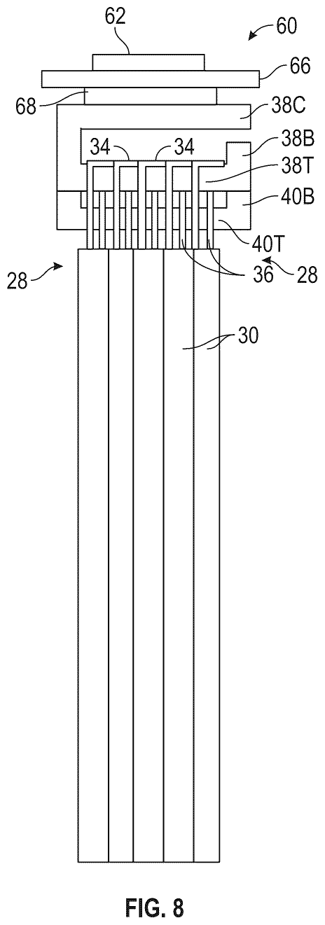

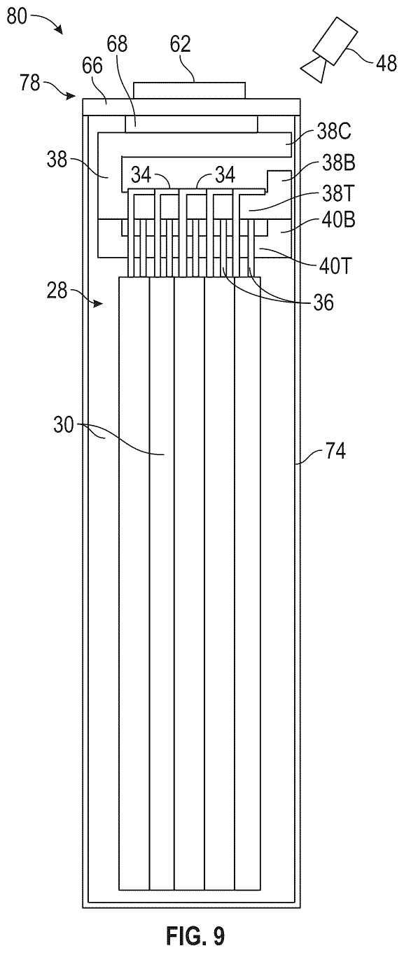

As shown in FIG. 8, the cap portions 38C and 40C of the cathode dowel 38 and the anode dowel 40, respectively, are bent in a mid-portion of the cathode dowel 38 and anode dowel 40 such that the cap portions 38C and 40C are parallel to the tab portions 38T and 40T. This positions the cap plate 66 such when the electrode assembly 28 with the cathode and anode dowels 38 and 40, and the cap assembly 66 can be inserted into a battery cell receptacle 74. The battery cell receptacle 74 may include a pouch or a metallic can with the cap plate 66 forming a portion of the battery cell enclosure 78 with the battery receptacle 74 as shown in FIG. 9 to form a secondary battery cell 80. In the illustrated example, the cap plate 66 can be welded directly to the battery cell receptacle 74 with the welder 48 to form the battery cell enclosure 78.

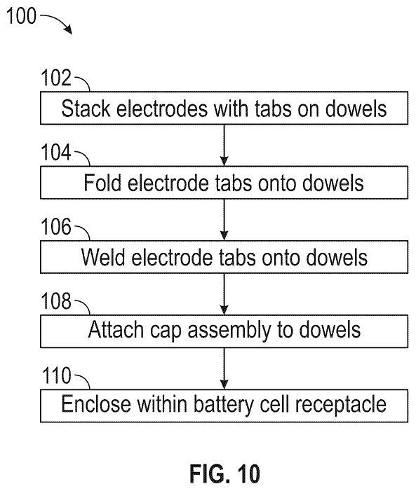

FIG. 10 illustrates a flow diagram of an example method 100 for manufacturing the secondary battery cell 80 shown FIG. 9. The blocks are shown as a representative example. Other orders of the blocks may be implemented to meet the criteria of a particular application. At block 102, the electrodes 30 are stacked on the cathode dowel 38 and the anode dowel 40 as shown in FIG. 4. While the electrodes 30 are being stacked, the cathode tab dowel opening 42 on each of the electrodes 30 are aligned with the cathode dowel 38 and the anode dowel openings 44 on each of the electrodes 30 are aligned with the anode dowel 40. Once stacking the electrodes 30 to complete the electrode assembly 28 has completed, the method 100 proceeds to block 104.

At block 104, a portion of the cathode tab 34 on each of the electrodes 30 distal of the cathode tab dowel opening 42 are folded onto the cathode dowel 38 and a portion of the anode tab 36 on each of the electrodes 30 distal of the anode tab dowel opening 44 are folded onto the anode dowel 40. With the example cathode tab 34C in FIG. 3C, the first portion of the cathode tab 34C distal of the cathode tab dowel openings 52 on each of the electrodes 30 is folded in a first direction and the second portion of the cathode tab 34C distal of the cathode tab dowel openings 52 on each of the electrodes 30 is folded in a second direction opposite the first direction. The same process can occur with an anode tab configured like the cathode tab 34C. Once the cathode and anode tabs 34 and 36 are folded onto the cathode and anode dowels 38 and 40, respectively, the method 100 proceeds to block 106.

At block 106, the portion of the cathode tab 34 distal of the cathode tab dowel opening 42 on each of the electrodes 30 is welded onto the cathode dowel 38 to secure the cathode tabs 34 to the cathode dowel 38. Similarly, the portion of the anode tabs 36 distal of the anode tab dowel opening 44 on each of the electrodes 30 is welded onto the anode dowel 40 to secure the anode tabs 36 onto the anode dowel 40. Prior to or after welding the cathode and anode tabs 34 and 36 to the cathode and anode dowels 38 and 40, a distal end of each of the cathode and anode dowels 38 and 40 are bent to be perpendicular or transverse to the tab portion 38T and 40T on the cathode and anode dowels 38 and 40, respectively. After the welding of the cathode and anode tabs 34 and 36, the method 100 proceeds to block 108.

At block 108, the cap assembly 60 is attached to the cathode dowel 38 and the anode dowel 40. In particular, the negative terminal weld plate 68 is welded to the cathode dowel 38 with the welder 48 and the positive terminal weld plate 70 is welded to the anode dowel 40 with the welder 48. This creates an electrical connection between the cathodes 31 and the negative terminal 62 and the anodes 32 and the positive terminal 64. In another example, the negative terminal weld plate 68 is integral with the cathode dowel 38 and the positive weld plate 70 is integral with anode dowel 40 such that they do not require welding.

Furthermore, a mid-portion of the cathode dowel 38 between the tab portion 38T and the cap portion 38C can be bent such that the tab portion 38T is parallel to the cap portion 38C, Similarly, a mid-portion of the anode dowel 40 between the tab portion 40T and the cap portion 40C can be bent such that the tab portion 40T is parallel to the cap portion 40C. Accordingly, this results in the mid-portions for each of the cathode and anode dowels 38 and 40 to extend transversely to the tab portions 38T and 40T as well as the cap portions 38C and 40C, respectively. Once the cap assembly 60 is positioned and attached, the method 100 proceeds to block 110.

At block 110, the electrode assembly 28 is placed within the battery cell receptacle 74. The cap plate 66 and the battery cell receptacle 74 are sealed together to form the battery enclosure 78. In one example, the cap plate 66 is welded to the battery cell receptacle 74 with the welder 48.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A secondary battery cell comprising:
a battery cell receptacle;
an electrode assembly including a plurality of electrodes, wherein each of the plurality of electrodes includes a cathode tab and an anode tab and the electrode assembly is at least partially enclosed within the battery cell receptacle;
a dowel extending through a tab dowel opening in at least one of the cathode tab or the anode tab on each of the plurality of electrodes; and
a cap assembly having a cathode portion connecting the cathode tab on each of the plurality of electrodes to a negative terminal, an anode portion connecting the anode tab on each of the plurality of electrodes to a positive terminal, and a cap at least partially forming a battery enclosure for the electrode assembly with the battery cell receptacle, wherein the dowel forms a portion of a connection in one of the cathode portion or the anode portion.

2. The secondary battery cell of claim 1, wherein a distal end of the dowel extends transversely to a portion of the dowel extending through the tab dowel opening on each of the plurality of electrodes.

3. The secondary battery cell of claim 1, wherein the tab dowel opening includes a perimeter having a rectangular shape.

4. The secondary battery cell of claim 1, wherein a tab portion of the dowel extending through the tab dowel opening on each of the plurality of electrodes is parallel to a cap portion of the dowel attached to the cap assembly.

5. The secondary battery cell of claim 4, wherein a mid-portion of the dowel located between the tab portion and the cap portion extends transversely to the tab portion and the cap portion.

6. The secondary battery cell of claim 1, wherein the battery cell receptacle includes one of a pouch or a can.

7. The secondary battery cell of claim 1, wherein the dowel is glued to a corresponding one of the cathode tab or the anode tab on each of the plurality of electrodes.

8. The secondary battery cell of claim 1, wherein the dowel includes a cathode dowel and the tab dowel opening includes a cathode tab dowel opening in the cathode tab on each of the plurality of electrodes with the cathode dowel extending through the cathode dowel opening on each of the plurality of electrodes.

9. The secondary battery cell of claim 1, wherein the dowel includes an anode dowel and the tab dowel opening includes an anode tab dowel opening in the anode tab on each of the plurality of electrodes with the anode dowel extending through the anode dowel opening on each of the plurality of electrodes.

10. The secondary battery cell of claim 1, wherein the dowel includes a cathode dowel and an anode dowel, the tab dowel opening includes a cathode tab dowel opening in the cathode tab of each of the plurality of electrodes with the cathode dowel extending through the cathode dowel opening on each of the plurality of electrodes and an anode dowel opening in the anode tab on each of the plurality of electrodes with the anode dowel extending through the anode dowel opening on each of the plurality of electrodes.

11. A method of manufacturing a secondary battery cell, the method comprising:
stacking a plurality of electrodes onto a cathode dowel and onto an anode dowel to form an electrode assembly, wherein the cathode dowel extends through a cathode tab dowel opening in a cathode tab on each of the plurality of electrodes and the anode dowel extends through an anode tab dowel opening in an anode tab in each of the plurality of electrodes;
folding a portion of the cathode tab on each of the plurality of electrodes distal of the cathode tab dowel opening onto the cathode dowel;
folding a portion of the anode tab on each of the plurality of electrodes distal of the anode tab dowel opening onto the anode dowel;
welding the portion of the cathode tab distal of the cathode tab dowel opening on each of the plurality of electrodes onto the cathode dowel;
welding the portion of the anode tabs distal of the anode tab dowel opening on each of the plurality of electrodes onto the anode dowel; and
enclosing the electrode assembly at least partially within a battery cell receptacle with a cap assembly, wherein the cap assembly includes a negative terminal in electrical communication with cathode tab on each of the plurality of electrodes and a positive terminal in electrical communication the anode tabs on each of the plurality of electrodes.

12. The method of claim 11, including bending a distal end of the cathode dowel to be transverse to a tab portion of the cathode dowel extending through the cathode tab dowel opening on each of the plurality of electrodes after stacking the plurality of electrodes.

13. The method of claim 12, including gluing the cathode tab on each of the plurality of electrodes to the cathode dowel and glueing the anode tab on each of the plurality of electrodes to the anode dowel.

14. The method of claim 12, including bending a distal end of the anode dowel to be transverse to a tab portion of the anode dowel extending through the anode tab dowel opening on each of the plurality of electrodes after stacking the plurality of electrodes.

15. The method of claim 14, including bending a mid-portion of the cathode dowel such that the tab portion of the cathode dowel is parallel to a cap portion of the cathode dowel attached to the cap assembly, wherein the mid-portion of the cathode dowel extends transversely to the tab portion of the cathode dowel.

16. The method of claim 15, including bending a mid-portion of the anode dowel such that a tab portion of the anode dowel is parallel to a cap portion of the anode dowel attached to the cap assembly, wherein the mid-portion of the anode dowel extends transversely to the tab portion of the anode dowel.

17. The method of claim 11, wherein folding the portion of the cathode tab on each of the plurality of electrodes includes folding a first portion of the cathode tab distal of the cathode tab dowel opening on each of the plurality of electrodes in a first direction and folding a second portion of the cathode tab distal of the cathode tab dowel opening on each of the plurality of electrodes in a second direction opposite the first direction.

18. The method of claim 11, including welding a cap plate of the cap assembly to the battery cell receptacle.

19. The method of claim 11, wherein the cap assembly at least partially encloses the electrode assembly within the battery cell receptacle.

20. A vehicle comprising:
a battery pack with a plurality of secondary battery cells, wherein at least one of the secondary battery cells includes:
a battery cell receptacle;
an electrode assembly including a plurality of electrodes, wherein each of the plurality of electrodes includes a cathode tab and an anode tab and the electrode assembly is at least partially enclosed within the battery cell receptacle;
a dowel extending through a tab dowel opening in at least one of the cathode tab or the anode tab on each of the plurality of electrodes; and
a cap assembly having a cathode portion connecting the cathode tab on each of the plurality of electrodes to a negative terminal, an anode portion connecting the anode tab on each of the plurality of electrodes to a positive terminal, and a cap at least partially forming a battery enclosure for the electrode assembly with the battery cell receptacle, wherein the dowel forms a portion of a connection in one of the cathode portion or the anode portion.
